(19) United States
(12) Patent Application Publication
(10) Pub. No.: US 2005/0133324 A1
(43) Pub. Date: Jun. 23, 2005

(54) Modular structure for energy absorption in head impacts on vehicle interiors

(75) Inventors: Arturo Soto Bailon, Burgos (ES); Julio Cesar Abajo Alonso, Burgos (ES)

Correspondence Address: OSTROLENK FABER GERB & SOFFEN, 1180 AVENUE OF THE AMERICAS, NEW YORK, NY, 100368403, US

(73) Assignee: Grupo Antolin Ingenieria S.A.

(21) Appl. No.: 10/848,642

(22) Filed: May 18, 2004

(30) Foreign Application Priority Data
Dec. 19, 2003 (EP) 03380300.8

(51) Int. Cl. F16F 7/12

(52) U.S. Cl. 188/377

(57) ABSTRACT

A modular structure for energy absorption useful in head impacts on vehicle interiors, comprising a set of deformable hollow bodies each having an open end section and the bodies are arranged in interconnected independent clusters. The hollow bodies in each cluster are joined by means of flexible bridges running between the open ends of adjacent bodies. The clusters are provided around their outline with flexible half bridges provided with mutual connection elements, a pin on one half bridge and a hole on the other half bridge.

### BACKGROUND OF THE INVENTION

The present invention refers to a modular structure for energy absorption of impacts in vehicle interiors, intended to become part of the interior lining of the ceiling of a vehicle, for the purpose of reducing the risks of injury caused to an occupant or occupants of a vehicle upon impact against the internal surface of the ceiling thereof.

The structure of the invention is applicable to all those parts of a vehicle interior susceptible to undergoing head impact of the occupants of said vehicle, especially in the case of accidents.

Until today, different types of solutions for protecting the body of the occupants in case of accident have been used, reducing the injuries caused by impact against them in any part of the vehicle.

All these solutions achieve their objective by means of the management of the kinetic energy generated and transmitted to the occupants during an impact, either by absorption of part of that energy or by distribution thereof towards other areas.

In order to achieve these objectives, the use of structures of different nature or constitution is known, among which are blocks of foamed plastic materials, plastic ribbed structures, structures based on deformable hollow bodies, deformable metallic structures, etc.

Foam blocks are three-dimensional elements of different foamed plastic materials, with different compositions, densities, rigidities, etc., which are capable of absorbing energy when compressed, either by destruction of their open cells, or by compression of their closed cells. Behavior is uniform inside each foam block, it being impossible to establish areas with different responses or with a progressive or sequential behaviour, i.e. they do not allow a differential control, neither by areas, nor in terms of impact severity, inside each absorbing element.

Plastic ribbed structures are shaped such that the ribs are capable of absorbing energy by deformation of the walls of the defined structures or by collapse thereof, for example when subjected to a compression, or when a body impacts against them. In principle, the geometry of the ribs and spatial arrangement determine their behavior. This type of structure requires a plastic base on which the ribs are placed, and which in turn needs to be coupled to the surface on which it is to work. The design of the ribbed structure thus conditions that of the surface and of the base plate itself. All this is due to the fact that, on the one hand, a good placement of said plastic base on the support surface in the vehicle or in the component is required, and on the other hand, the injection process used for manufacturing this type of plastic structures conditions and limits its geometry.

Structures based on deformable hollow bodies can be considered as an evolution of ribbed structures, in which energy absorption capability is increased by replacing the walls or ribs with other geometries with different manners of collapsing. These structures also require a plastic base on which the geometric figures are placed, and the base in turn needs to be coupled to the surface on which it is to work. The design of the base plate of the structure itself conditions the shape of the surface. They therefore present the same problem as ribbed structures, but as they have more complex geometries than the simple walls of a rib, the limitations in terms of possible shapes and designs are greater.

Finally, deformable metallic structures are widely applied in other fields of passive safety, for example, deformable impact barriers usually used in impact tests. The geometry and shape of these structures can either be similar to any of those previously mentioned in plastic, or can have a specific shape. The main limitation is their cost, as well as the aforementioned limitations in the case of producing any of the types of the structures mentioned.

The structure of the invention is based on hollow bodies of plastic material which present an open end section and which can adopt a frusto-conical or frusto-pyramidal shape etc., and have an open major base.

A structure of the type discussed is disclosed, for example, in Japanese patent 56131849. According to that patent, the structure is made up of at least two bodies which can adopt the shape of a hollow cone and which are joined to a support in the shape of a plate. The hollow bodies are furthermore linked by connection ribs. A similar construction is described in document EP 0863056, where the structure is also made up of hollow bodies, which can adopt a cylindrical or conical shape and which project from or are joined to a support base, furthermore being connected by intermediate ribs. With the construction discussed, the structures must be coupled to the surface on which they are assembled through the plate or plastic base, which conditions the design of the surface on which it is applied and of the base plate itself, since the arrangement of these structures requires a good placement of the base plate on the support surface on which it is arranged. Furthermore, as has already been pointed out, the manufacturing process used for this type of structure conditions and limits its geometry. Since the hollow bodies are connected by the base plate and by intermediate ribs and partitions, their capability of adaptation and of effectiveness are reduced.

Another structure of the type set forth is disclosed in Japanese patent 9150692. According to that patent, the structure is made up of hollow bodies, for example of a frusto-conical shape with an open major base, which are joined by intermediate ribs, having as a fundamental characteristic the fact that the whole structure is a single part. This circumstance implies a problem when having to modify the initially defined structure according to the different requirements which need to be achieved for each specific situation and in the different application areas. This problem is of special importance in the test and validation phases, in which each geometric modification to be validated implies expensive and relatively slow changes in design and in the manufacturing tools of the prototypes to be tested. On the other hand, in all the analysed cases, since all the hollow bodies are fixed to the base plate and the latter has a predefined rigid shape, they are incapable of absorbing the geometric diffusions due to the usual tolerances in the working area, which prevents the structure from perfectly adapting itself to the zone to be protected, making the correct support thereof difficult and thus deducting efficacy from the system.

### SUMMARY OF THE INVENTION

The object of the present invention is to eliminate the problems mentioned by means of a structure of the type described, constituted such that it allows a perfect adaptation to the surface to be protected, and additionally to introduce different shapes in a versatile manner.

The present invention develops a flexible and adaptable structure, formed by hollow bodies of different shapes and dimensions, joined together by flexible elements, without the need to use a uniform base plate. In addition to the high flexibility offered, this construction, allows the structure to be adaptable to the geometry of any support surface.

As initially indicated, the structure of the invention is of the type comprised of a set of deformable hollow bodies which present an open end section and which can adopt a frusto-conical shape, with an open major base.

The structure of the invention is characterized in that the hollow bodies are arranged in independent clusters. In each cluster, the bodies are placed with their open bases in coplanar position and joined together by means of flexible bridges running between the edges of the open bases of adjacent bodies. These clusters will preferably have a regular polygonal outline, and will have, from that outline, flexible half bridges provided with mutual connection means, which project from the edge of the open bases of at least part of the hollow bodies occupying outer positions in said clusters.

The hollow bodies in each cluster will be equal to one another in the cluster, whereas they can have different dimensions and shapes in different clusters. Furthermore, the hollow bodies in each cluster will preferably be aligned following two perpendicular directions, and will be situated at equidistant positions.

In this way, the structure of the invention will be of a modular constitution, based on clusters of outlines of equal or different dimensions, the structure being able to include clusters with deformable hollow bodies of different dimensions and/or shapes.

In this way, the structure of the invention can be comprised of several clusters or modules which are joined or connected together through the flexible half bridges, for which reason it will be possible to use different combinations of modules of deformable hollow bodies with different dimensions, adapting each shape to the different severities at the different possible points of impact in the vehicle interior, or to the different geometries thereof.

Once the structure of the invention is formed, starting from clusters or modules, all the hollow bodies are joined or linked by means of flexible bridges, such that the relative position of all the deformable hollow bodies on the work surface is maintained, maintaining however the independence of the behavior of each one of the deformable hollow bodies.

The connection means of the flexible half bridges can consist of a pin perpendicularly projecting from the end of one of the half bridges, and of an orifice finishing off the free end of the complementary half bridges, for the mutual connection by means of introducing the pins of determined half bridges through the orifices of complementary half bridges.

The hollow bodies making up the structure of the invention, preferably of a frusto-conical shape, are provided with an outlying rim around the open section or base, from which the flexible connection bridges between hollow bodies and the external half bridges project.

The advantages provided by the structure of the invention are the following:

Easy adaptation of the solution to different shapes and/or different specifications, individually changing the number, the arrangement and the size of the deformable hollow bodies used in a simple manner, being able to optimise the structure for each vehicle, for each impact area and for each specific situation.

A wide variety of geometric shapes can be obtained with a limited number of basic geometries, covering a large variety of different situations.

Modifications of the structure only imply changing the combination of deformable hollow bodies used, the behavior of which is perfectly known and completely independent of the rest of the structure, in comparison to what occurs in the structures assembled on plates, where the behavior of each deformable hollow body cannot be made independent, which implies the need to carry out a complete study for each new shape.

The flexibility of the system allows perfect adaptation to the work surface, absorbing any type of geometric deviation, whereas in the known systems, since the structure is rigid, it is not possible to correct possible geometric diffusions, for which reason the coupling will always be worse, to the detriment of their behavior in case of impact.

A wide variety of geometric shapes can be obtained with a limited number of basic geometries, covering a large variety of different situations.

In short, the invention is basically focused on achieving a structure of deformable hollow bodies which have the capability to absorb energy when they collapse by being subjected to a determined force. In these structures, the hollow bodies forming them are joined together by means of flexible ribs allowing each deformable hollow body to behave independently of the rest of the structure. Furthermore, the structure is made up of clusters or modules which can be of equal or different dimensions, and which can also include hollow bodies of equal of different sizes, allowing very different shapes and structures to be obtained by simply changing the number and type of assembled elements.

Furthermore, said connection ribs between adjacent deformable hollow bodies are rigid enough to maintain the relative positions between them, but with enough flexibility to make the adaptation of the structure to surfaces with different shapes possible.

The structure of the invention is specially indicated in the construction of components for head impact absorption in automobiles, which are usually placed between the trim of the ceiling and the structure of the vehicle roof.

For the purpose of better understanding the features and advantages of the structure of the invention, a more detailed description is made below of a preferred embodiment thereof with the help of the attached drawings, which show a non-limiting embodiment example in which the deformable hollow bodies are conical frustums which are open and joined at their major bases.

### BRIEF DESCRIPTION OF THE DRAWINGS

FIG. 1 shows a perspective view of a structure constructed according to the invention.

FIG. 2 shows a partial section view of the structure of the invention taken following the II-II cut line of FIG. 1.

FIG. 3 shows a schematic section view of a structure constituted according to the invention, assembled on the interior surface of the ceiling trim of a vehicle.

### DESCRIPTION OF A PREFERRED EMBODIMENT

The structure of the invention, as has been set forth, is comprised of a set of deformable hollow bodies with an open end section. These bodies are able to adopt a frusto-conical shape with an open lower base.

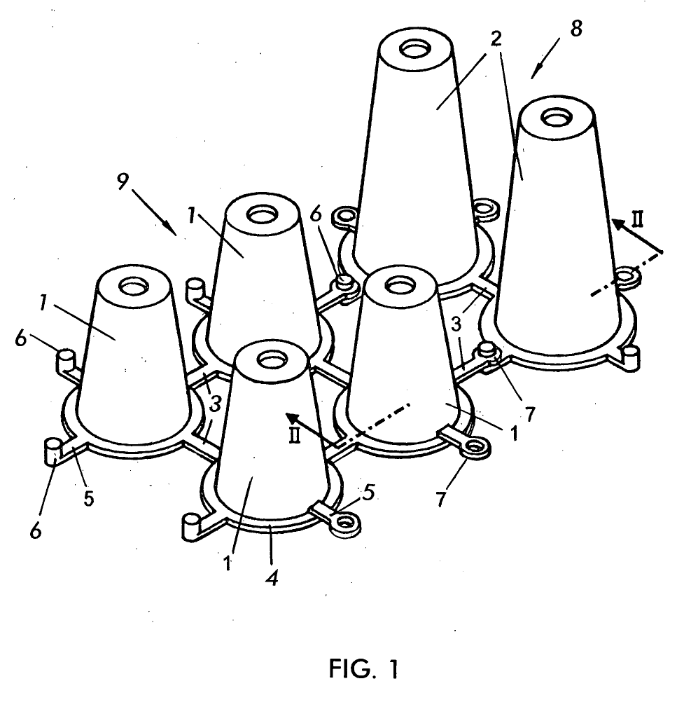

FIG. 1 shows a structure constructed according to the invention including two-dimensional frusto-conical shaped hollow bodies, minor ones referenced with number 1 and major ones referenced with number 2. The conical bodies 1 and 2 form two different clusters or modules. In each of one these clusters, the conical bodies, referenced with number 1 in one case and with number 2 in the other, are joined by intermediate flexible bridges generally referenced with number 3.

In the two clusters or modules, the frusto-conical bodies 2 are encircled from the open major base by an outlying rim 4 from which the flexible bridges 3 project.

Furthermore, according to another feature of the invention, flexible half bridges 5 finished off by mutual connection means, referenced with numbers 6 and 7, project from each cluster or module. These flexible half bridges 5 project from the outlying rim 4 of the frusto-conical bodies 1 occupying outer positions in the cluster or module, being situated in a position diametrically opposite to certain flexible bridges 3.

Preferably, fixing means 6 and 7 are constituted respectively of male and female elements. The male element 6 consists of a pin perpendicularly projecting from the half bridge 5, whilst the female element 7 is constituted of a hole formed at the end of the corresponding half bridge, with a section coinciding to that of pin 6. In this way, as seen in FIG. 1, the pins 6 of the cluster or module 8 are inserted through the holes or orifices of the cluster or module 9.

In the example represented in FIG. 1, the module 9 includes four frusto-conical bodies and the module 8 includes two. Nevertheless, each cluster or module can include a greater number of hollow bodies, which are preferably aligned according to two perpendicular directions, the cluster or module having a preferably regular polygonal outline, for example square or rectangular.

With the construction set forth, a structure can be made up of two or more modules, all with conical bodies of equal or different dimensions, according to the specific application of the structure.

On the other hand, the hollow bodies can adopt a different shape to that represented in the drawings, for example a frusto-pyramidal shape.

With the construction set forth, as represented in FIG. 3, a structure covering the internal surface of the ceiling 10 of a vehicle can be provided. This structure is made up of a series of clusters or modules, including conical bodies referenced with numbers 11, 12 and 13 of different dimensions, each of them adapted to the exact point to be covered.

This possibility of obtaining a structure adapted to the surface to be covered at each point implies a considerable advantage, and is achieved as a result of the formation of the structure by means of independent clusters or modules, which are joined together by means of flexible bridges.

Additionally, as indicated, the structure of the invention implies a great advantage when it comes to applying it to vehicle impact tests.

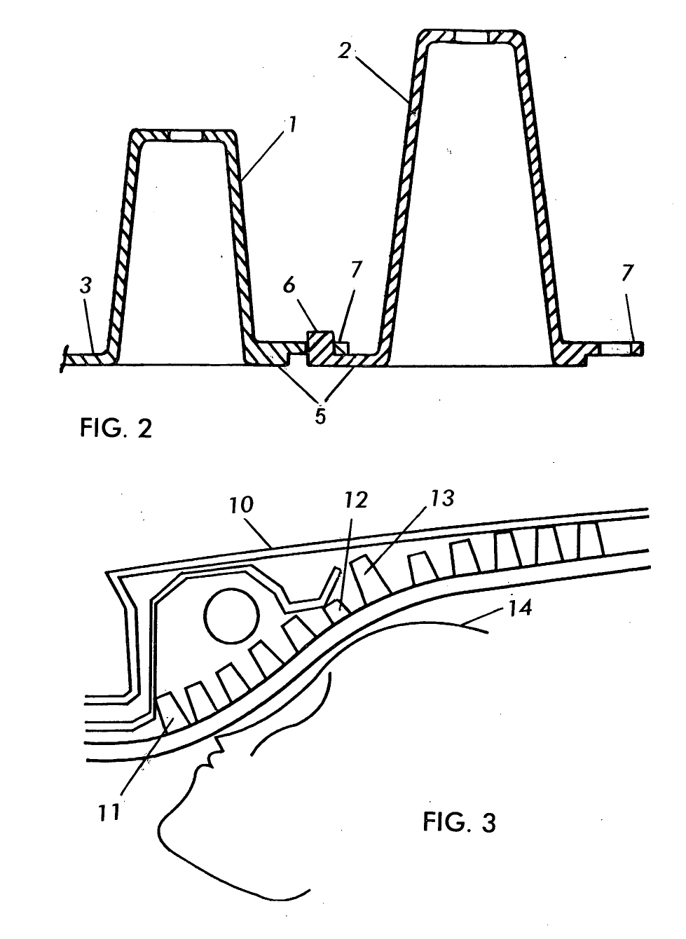

Additionally, as can be understood, the connection means between consecutive clusters or modules can be different to the pin 6 and hole 7 shown in FIGS. 1 and 2. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

1. A modular structure for energy absorption in impacts comprising;
a set of deformable hollow bodies, each body having an open end section;
the bodies being arranged in independent but interconnected clusters, in each cluster, the respective bodies are placed with their open bases initially on a single plane;
flexible bridges linking the bodies in each cluster together by the flexible bridges running between the open bases of adjacent bodies in the cluster;
following their outline, each cluster having flexible half bridges; and
mutual connection elements on each half bridge which project from an edge of the open bases of at least some of the hollow bodies of each cluster which occupy outer positions in the clusters.

2. A structure according to claim 1, wherein the hollow bodies in each cluster are aligned with respect to two perpendicular directions and the bodies are at equidistant positions.

3. A structure according to claim 1, wherein the hollow bodies are provided, around their open bases, with an outlying rim from which project the flexible connection bridges that are between the hollow bodies and the outer half bridges.

4. A structure according to claim 1, wherein all of the hollow bodies within each cluster are the same.

5. A structure according to claim 1, comprising a plurality of the clusters, each of the plurality of clusters includes a different respective number of the hollow bodies.

6. A structure according to claim 1, wherein the bodies of different ones of the clusters have different dimensions.

7. A structure according to claim 1, wherein the mutual connection elements of the flexible half bridges comprise a hole at one half bridge from one cluster and a pin at another half bridge from an adjacent cluster, and the pin can be received in the hole for coupling together the adjacent cluster.

8. A structure according to claim 7, wherein each pair of connectable flexible half bridges has a free end wherein the hole and the pin are at a respective free end of the respective half bridge.
